(19) United States
(12) Patent Application Publication
(10) Pub. No.: US 2009/0015408 A1
(43) Pub. Date: Jan. 15, 2009

(54) HANDY-TYPE WIRELESS TAG READER/WRITER

(76) Inventors: Yoshinori Asai, Izunokuni-shi (JP); Hidekazu Mori, Mishima-shi (JP); Atsushi Ishikawa, Izunokuni-shi (JP); Sadayoshi Mochida, Numazu-shi (JP)

Correspondence Address: PATTERSON & SHERIDAN, L.L.P., 3040 POST OAK BOULEVARD, SUITE 1500, HOUSTON, TX, 77056, US

(21) Appl. No.: 12/044,707

(22) Filed: Mar. 7, 2008

Related U.S. Application Data
(60) Provisional application No. 60/948,923, filed on Jul. 10, 2007.
(60) Provisional application No. 60/948,926, filed on Jul. 10, 2007.
(60) Provisional application No. 60/948,927, filed on Jul. 10, 2007.
(60) Provisional application No. 60/948,931, filed on Jul. 10, 2007.

(30) Foreign Application Priority Data
Jan. 24, 2008 (JP) 2008-013859

(51) Int. Cl. G08B 13/14

(52) U.S. Cl. 340/572.1

(57) ABSTRACT

A switch 112a is provided at the middle apart of a handle member 114 and may be pushed to start radiating electric waves. Another switch 112b is provided near the distal end of the handle member 114 and may be pushed to stop radiating electric waves.

### CROSS-REFERENCE TO RELATED APPLICATIONS

This application is based upon and claims the benefit of priority from the Provisional Patent Application Ser. 60/948,923, filed on Jul. 10, 2007, Ser. 60/948,926, filed on Jul. 10, 2007, Ser. 60/948,927, filed on Jul. 10, 2007, Ser. 60/948,931, filed on Jul. 10, 2007, and Japanese Patent Application No. 2008-13859, filed on Jan. 24, 2008; the entire contents of which are incorporated herein by reference.

### BACKGROUND OF THE INVENTION

1. Field of the Invention

The present invention relates to a reading apparatus for reading media, each having a wireless tag attached to it, the apparatus being a handy-type wireless tag reader/writer that can be moved while held at its antenna unit.

2. Description of the Related Art

Radio frequency identification (RFID) systems are well known as technology that identifies information about products during manufacture and commercial transactions. Most RFID systems comprise wireless tags, a wireless tag reader/writer, and a host computer. Each wireless tag has a tiny wireless chip (integrated circuit). The wireless tag reader/writer can receive electric waves transmitted from any wireless tag, in non-contact manner, to obtain the tag data containing the tag ID, and can write a given ID into the wireless tag. The host computer obtains the tag data from the wireless tag reader/writer and processes the tag data. Thus, the tag data, which is information about the product to which the wireless tag is attached, can be read by using the wireless tag reader/writer in non-contact manner. The tag data can be sent via the driver incorporated in the host computer and can be utilized in various applications. This is why the RFID system is used in various business fields.

Wireless tag reading apparatus are known, each being able to read information from the wireless tags, even if the wireless tags are attached to thin articles that are placed on the shelves, without taking the articles out of the shelves. (See Japanese Patent No. 3551962.) The wireless tag reading apparatus of this type comprises an antenna and a grip part. The antenna can achieve radio communication with wireless tags attached to articles, each wireless tag holding specific data about the article to which it is attached. The holding part can be held by the operator of the wireless tag reading apparatus. The antenna outer casing member that incorporates the antenna is shaped like a thing plate and can therefore be inserted between the adjacent articles. Further, the antenna outer casing member projects from the housing of the wireless tag reading apparatus so that both sides of the thing plate are open, rendering the reader/writer a hand-held one.

Any wireless tag reading apparatus of this type has many high-frequency cables. To maintain its high reading ability, this type of a wireless tag reader/writer is used, while reducing the power attenuation on the cables. Whether power is dissipating from the antenna unit or not is determined by measuring the intensity of electric waves being radiated by means of, for example, a spectrum analyzer or by reading and examining the tag data.

The operator who holds a wireless tag reading apparatus at the antenna unit, with one hand, and is reading the wireless tags attached to articles put on shelves, may stop reading the wireless tags.

Any handy-type wireless tag reading apparatus, which the operator holds at the antenna unit and moves to read wireless tags, has a start switch the operator may operate to start reading the wireless tags. Only one start switch is provided on the handy-type wireless tag reading apparatus.

Inevitably, the operator needs to operate the same start switch to read the wireless tags attached to articles put on shelves, no matter whether the articles are placed on an upper shelf or on a lower shelf.

Hence, it is difficult for the operator to hold the antenna unit or to operate the start switch.

Further, the high-frequency cables mentioned above are liable to damages when exerted with an excessive load. To determine whether the high-frequency cables have failed to work well, or whether power is dissipating from the antenna unit, the operator may use a spectrum analyzer, which is an expensive device. For the same purpose, the operator may operate the wireless tag reading apparatus to read tag data. Either method is not practical.

Moreover, some measures should be taken not only for the case were the operator stops reading wireless tags, but also for the case where the operability of the wireless tag reading apparatus whose antenna unit incorporates a power supply. However, such measures are not taken in any wireless tag reading apparatus of the type disclosed in Japanese Patent No. 3551962.

### BRIEF SUMMARY OF THE INVENTION

According to embodiments of the present invention, an object of the invention is to provide a handy-type wireless tag reader/writer that exhibits high operability in reading tag data.

The present invention may provide a handy-type wireless tag reader/writer that has a wireless tag reader/writer unit configured to control communication with a wireless tag, and a hand-held antenna unit connected to the wireless tag reader/writer unit by a cable. The hand-held antenna unit comprises: an antenna unit configured to transmit a response requesting electric wave to the wireless tag under the control of the wireless tag reader/writer unit, and to receive a response electric wave that the wireless tag reader/writer unit transmits in response to the response requesting electric wave; a grip part attached to the antenna unit; and at least two switches provided on the grip part and configured to cause the antenna unit to start transmitting the response requesting electric wave when the wireless tag reader/writer unit is prepared to transmit the response requesting electric wave and to stop transmitting the response requesting electric wave while the response requesting electric wave is being transmitted.

### BRIEF DESCRIPTION OF THE DRAWINGS

FIG. 1 is a block diagram showing the overall configuration of a wireless tag information management system according to an embodiment of the present invention;

FIG. 2 is a diagram explaining the configuration of the hand-held antenna type wireless tag reader/writer incorporated in the wireless tag information management system;

FIG. 3 is a diagram explaining the configuration of the hand-held antenna unit of the handy-type wireless tag reader/writer;

FIG. 4 is another diagram explaining the configuration of the hand-held antenna unit of the handy-type wireless tag reader/writer;

FIG. 5 is a schematic diagram showing the electric wave detecting unit provided in the handy-type wireless tag reader/writer;

FIG. 6 is a diagram illustrating the circuit configuration for converting electric waves detected by the electric wave detecting unit into a digital signal;

FIG. 7 is a flowchart explaining the process that the wireless tag reader/writer performs the digital signal acquired from the electric waves which the electric wave detecting unit has detected;

FIGS. 8A and 8B are diagrams explaining the holding base of the hand-held wireless tag reader/writer, which serves as main unit cover as well;

FIGS. 9A and 9B are perspective views explaining the lower section of the hand-held antenna unit;

FIG. 10 is a perspective view of the hand-held antenna unit, as viewed from the antenna cover; and

FIG. 11 is a block diagram showing the overall configuration of a wireless tag information management system according to another embodiment of the present invention.

### DETAILED DESCRIPTION OF THE INVENTION

Embodiments of the present invention will be described with reference to the accompanying drawings.

### First Embodiment

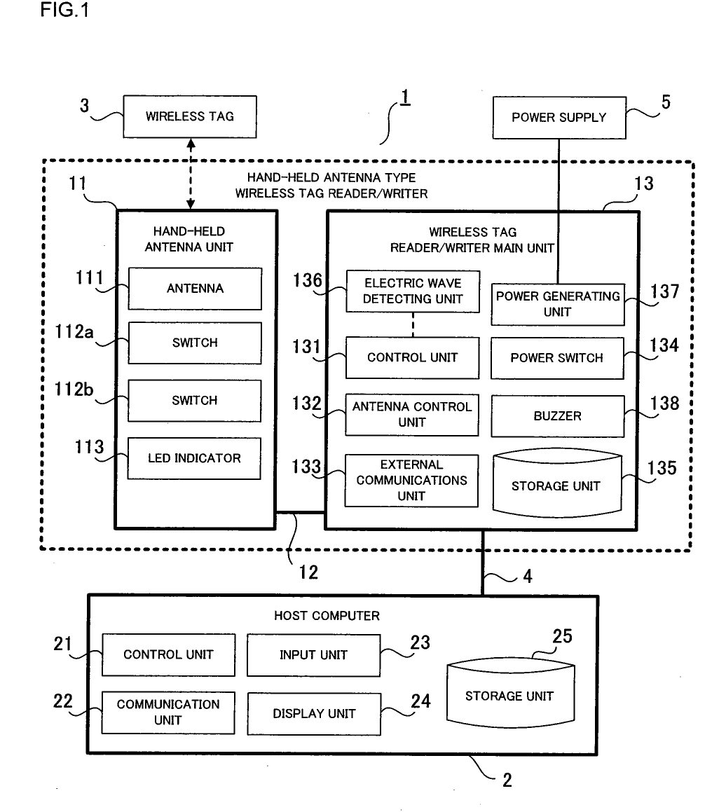

FIG. 1 is a block diagram showing the overall configuration of a wireless information management system writer including a handy-type wireless tag reader/writer according to a first embodiment of the present invention.

As FIG. 1 shows, the wireless tag data management system comprises a handy-type wireless tag reader/writer 1, a host computer 2, and a wireless tag 3. The wireless tag reader/writer 1 is a handy type whose antenna unit is separated from the main unit. (Hereinafter, referred to as hand-held antenna type) The hand-held antenna type wireless tag reader/writer 1 is connected to the host computer 2 by, for example, a USB cable 4.

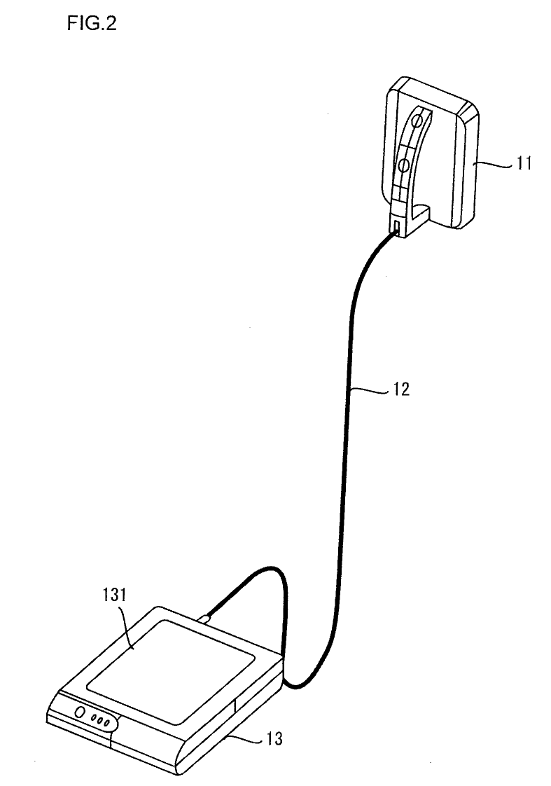

FIG. 2 is a diagram explaining the configuration of the hand-held antenna type wireless tag reader/writer 1. As FIG. 2 shows, the hand-held antenna type wireless tag reader/writer 1 comprises a hand-held antenna unit 11, a cable 12, and a wireless tag reader/writer main unit 13.

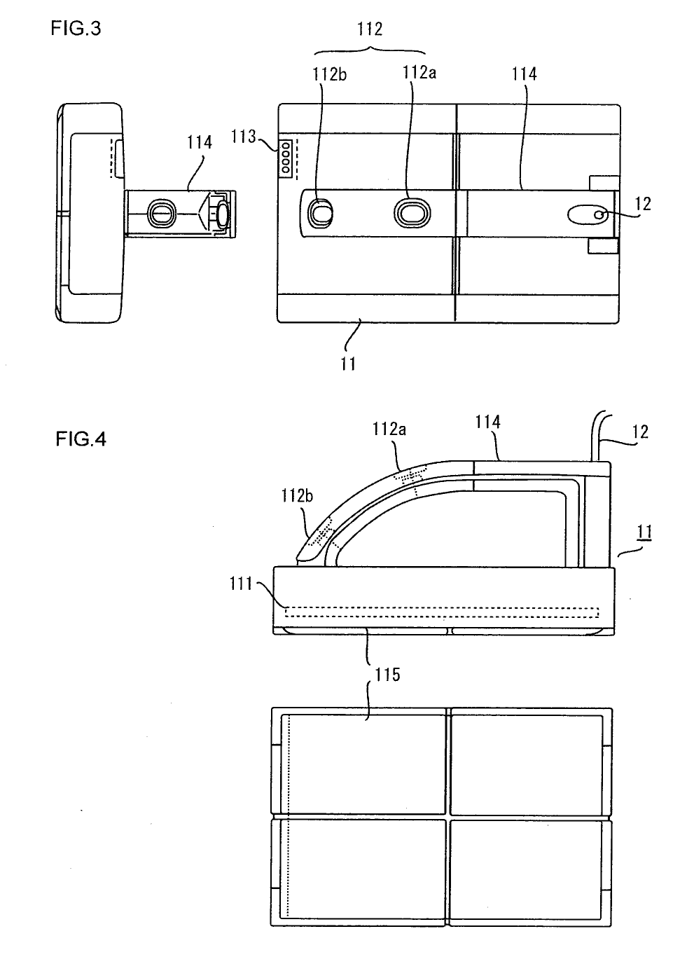

FIG. 3 is a diagram explaining the configuration of the hand-held antenna unit 11, one part showing the unit 11 as viewed from the front and the other part showing the unit 11 as viewed from above. FIG. 4 is another diagram explaining the configuration of the hand-held antenna unit 11, one part showing the unit 11 as viewed from one side and the other part showing the unit 11 as viewed from below. As seen from FIGS. 3 and 4, the hand-held antenna unit 11 comprises an antenna 111, a switch 112, and an LED indicator 113. The antenna 111 transmits and receives electric waves to and from the wireless tag 3. The switch 112 may be operated to make the antenna control unit 132 starts and stops transmitting electric waves. The LED indicator 113 emits light, informing the operator of the operating state of the wireless tag reader/writer main unit 13. A handle member 114 is provided on the upper surface of the hand-held antenna unit 11. On the handle member 114, the switch 112 is amounted. The switch 112 may be pushed to start and stop transmitting electric waves. The switch 112 will be described later in detail.

The LED indicator 113 is provided to indicate whether the main power supply of the hand-held antenna type wireless tag reader/writer 1 is ON or OFF, the transmission state of the electric wave, whether the data-reading has completed or not, and whether an reading error has developed or not. Seeing the LED indicator 113, the operator can push the switch unit 112a or 112b with one hand, while holding the hand-held antenna unit 11 with the other hand and obtain various information during reading operation.

The wireless tag reader/writer main unit 13 comprises a control unit 131, an antenna control unit 132, an external communications unit 133, a power switch 134, and a storage unit 135. The control unit 131 is a central processing unit. The antenna control unit 132 controls the antenna 111. The external communications unit 133 performs communication with the host computer 2. The power switch 134 may be operated to turn on and off the main power supply. The storage unit 135 stores various programs.

When controlled by the antenna control unit 132, the antenna 111 transmits or receive electric waves of a prescribed frequency, to and from the wireless tag 3 that exists in a given communication region. More specifically, the antenna 111 generates an electric wave (hereinafter referred to as “response requesting electric wave”) from the information and instruction signals given by the antenna control unit 132. The response requesting electric wave requests the wireless tag 3 to make a response to the hand-held antenna type wireless tag reader/writer 1. On receiving the response requesting electric wave, the wireless tag 3 generates drive power, which activates the integrated circuit (not shown) incorporated in the wireless tag 3. The wireless tag 3 transmits a electric wave (hereinafter referred to as “response electric wave”), which has been generated by modulating the tag data stored in the wireless tag 3, to the hand-held antenna type wireless tag reader/writer 1. In the wireless tag reader/writer 1, the antenna control unit 132 demodulates the response electric wave supplied from the antenna 111 via the cable 12, thus generating tag data.

When operated, the switch 112 causes the antenna control unit 132 to start or stop transmitting the response requesting electric wave. That is, the control unit 131 determines which switch unit, the switch unit 112a or the switch unit 112b, has been pushed, thereby controlling the antenna control unit 132. Hence, before the switch 112 is pushed, the response requesting electric wave will not be transmitted the even if the host computer 2 instructs the wireless tag reader/writer main unit 13 to start reading data and the control unit becomes in a wait state to be pushed. When the switch 112 is pushed, the response requesting electric wave is transmitted to the wireless tag 3. Conversely, to make the antenna 111 stop transmitting the response requesting electric wave, the operator again pushes the switch 112. It is desired that the host computer 2 should also stop the transmission of the response requesting electric wave. Note that electric waves should be radiated only when necessary to read tag data, for pace-marker wearing people who sit near the wireless tag reader/writer 1.

Assume that articles having a wireless tag are placed on shelves. When the operator pushes the transmission start switch 112 in order to read tag data from any article on an upper shelf, the wireless tag reader/writer 1 may read the tag data from an article placed on a lower shelf in some cases. This is inevitable, since the operator can hardly push the switch 112 while steadily holding the handle member 114, or can hardly holding the handle member 114, while pushing the switch 112. In short, the wireless tag reader/writer main unit 13 is hard to operate unless some appropriate measures are taken.

This is why the switch 112 for being pushed to radiate electric wave comprises a plurality of switches, each of which causes the antenna 111 to start transmitting electric waves when pushed and to stop transmitting the electric waves when pushed again. More specifically, two switches 112a and 112b are provided on the handle member 114, spaced from each other in the lengthwise direction of the handle member 114. That is one switch 112a is provided at the middle part of the handle member 114, whereas the other switch 112 b is provided near the distal end of the handle member 114, or remote from the cable 12. This is because, if the operator holds the hand-held antenna unit 11 with one hand, he or she must stretch the hand in order to read tag data from an article placed on a relatively high shelf. In this case, considering the operability, the operator may push the switch 112a that is provided at the middle part of the handle member 114. To read tag data from an article placed on a relatively low shelf, the operator holds the hand-held antenna unit 11 at the distal part of the handle member 114, as if hanging the unit 11 from the hand. In this case, the operator may push the switch 112b that is provided near the distal end of the handle member 114.

These two switches 112a and 112b, which are in the ON state, function in totally the same way in that either makes the antenna 111 start radiating electric waves in order to read tag data. In other words, the operator moves the hand-held antenna unit 11, scanning the article, while pushing the switch 112a or 112b.

Since the switch 112 is actually two switches 112a and 112b, one for scanning any article placed on a high shelf, and the other for scanning any article placed on a low shelf, the operator need not grip the handle member 114 at one part or another part in accordance with the position of the article that should be scanned. Having two switches 112a and 112b, the wireless tag reader/writer excels in operability.

As FIG. 1 shows, the wireless tag reader/writer main unit 13 has a buzzer 138, which generates sound, informing the operator that reading operation has been stopped, the wireless tag 3 has been detected or a trouble has developed in the wireless tag reader/writer 1. The buzzer 138 is controlled by the control unit 131.

Since the cable loss should be minimized, the cable 12 is a high-frequency cable, such as a coaxial cable. The cable 12 can have any given length.

High-frequency cables are not resistant to an excessive dynamic load, however, and are likely to break when applied with an excessive load. If the reading of tag data through the cable 12 failed, it should be determined where the cause exists in the cable. Therefore, the present embodiment incorporates a mechanism for detecting a breakage in the high-frequency cable 12.

The present embodiment has a electric wave detecting unit 136, which is provided in the wireless tag reader/writer main unit 13. The configuration of the electric wave detecting unit 136 will be outlined with reference to FIG. 5. FIG. 5 shows a configuration the unit 136 may have. As shown in FIG. 5, the electric wave detecting unit 136 comprises an electric wave detecting antenna 401, an LED 402, and a rectifying diode 403.

The electric wave detecting antenna 401 is provided to receive power transmitted from the antenna 111 of the hand-held antenna unit 11. Thus, it is appropriate to determine the length of the electric wave detecting antenna 401 in accordance with wavelength λ, which is based on the oscillation frequency.

In the present embodiment, the electric wave detecting antenna 401 has a length of λ/2, where λ is the operating frequency of the wireless tag 3. Needless to say, the antenna 410 may have length of λ/4, instead.

When the electric wave detecting antenna 401 receives a electric wave having length λ determined by the oscillation frequency from the antenna 111 of the hand-held antenna unit 11, it undergoes resonance, generating a current. The rectifying diode 403 suppresses the flow of the current, supplying the current to the anode of the LED 402. As a result, the LED 402 emits light.

In the present embodiment, the antenna control unit 132 is connected to the hand-held antenna unit 11 by the high-frequency cable 12. Therefore, the high-frequency cable 12 may be cut more often than not. If the high-frequency cable 12 is cut, the hand-held antenna unit 11 transmits no electric waves, and no tag data can be read from the wireless tag 3. If the hand-held antenna unit 11 transmits any electric waves, the LED 402 blinks. Seeing the LED 402 emitting light or no light, the operator can easily know whether the reader/writer 1 is operating well or whether the wireless tag 3 is broken.

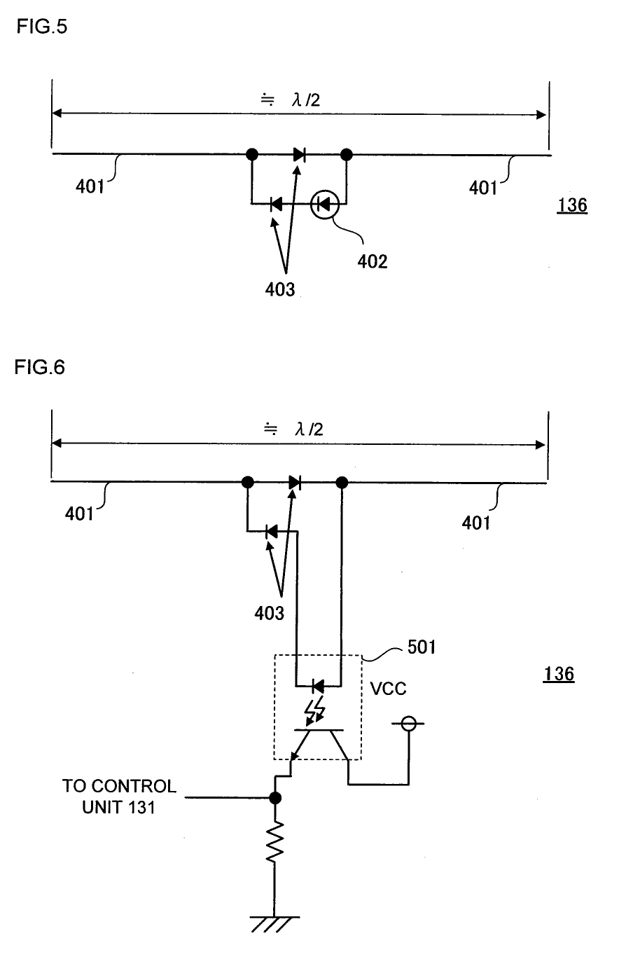

FIG. 6 is a diagram illustrating a circuit configuration that may be used to convert the electric wave detected by the electric wave detecting unit 136 into a digital signal.

This embodiment uses a photocoupler 501, which detects whether the cable 12 is cut or not and generates a digital signal representing the state of the cable 12.

The photocoupler 501 has a light-emitting diode, which is connected to the electric wave detecting unit 136, the collector of a light-receiving transistor is connected to an operating voltage source VCC, and the emitter of the light-receiving transistor is connected to the control unit 131 of the wireless tag reader/writer 1. Hence, an output signal of the photocoupler 501 can be supplied to the wireless tag reader/writer 1.

If the circuit configuration of FIG. 6 is used, a high-level signal is output to the control unit 131 of the wireless tag reader/writer 1 when the electric wave detecting unit 136 detects a electric wave being transmitted. As long as the signal remains at high level, the control unit 131 determines that electric waves are being radiated. If the signal is at low level, the control unit 131 cannot detect electric waves. Thus, whether electric waves are being transmitted can be determined in accordance with the level of the digital signal.

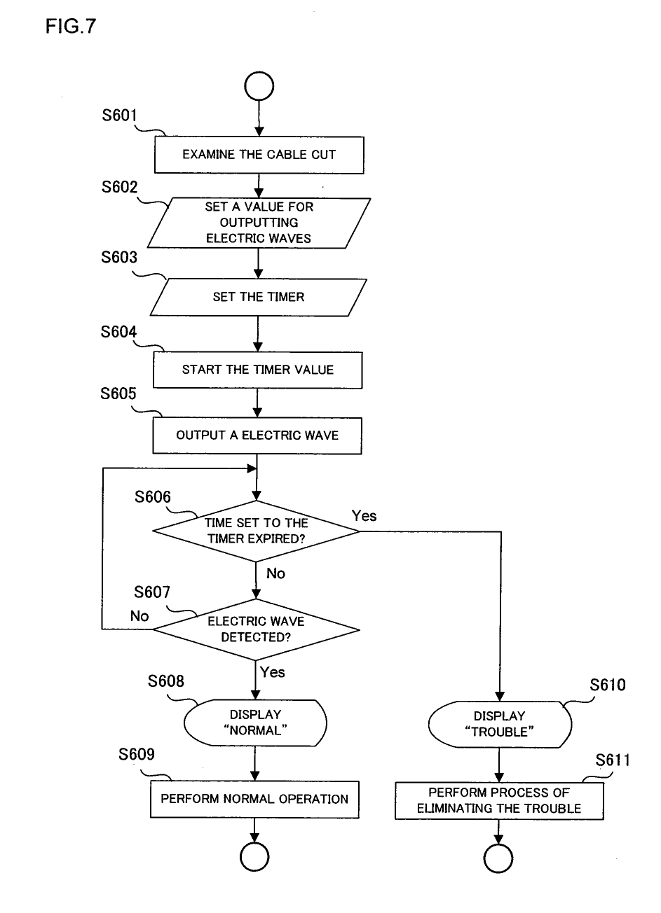

FIG. 7 is a flowchart explaining the process that the wireless tag reader/writer 1 performs the digital signal at high level, which the electric wave detecting unit 136 has detected.

Before reading tag data from the wireless tag 3, the operator may want to know whether data can be read from the tag 3 or whether any trouble has developed. In this case, the operator selects the cable-cutting detecting function that is prepared by the application installed in the host computer 2.

When the cable-cutting detecting function is selected, the host computer 2 transmits a command to the cable-cutting detecting function 1. On receiving the command, the cable-cutting detecting function starts operating to detect a cable cutting, if any (Step S601).

On receiving a command indicating the cable cutting, the wireless tag reader/writer 1 sets an output value of a electric wave (Step S602), and sets a time value for setting a time required for detecting, because it is meaningless to keep detecting the cable cutting for a long time.

Next, a timer is started (Step S604). The timer value is thereby counted up.

Then, a electric wave is transmitted (output) from the antenna 111 (Step S605). At this time, the operator moves the antenna 111 of the hand-held antenna unit 11 toward the electric wave detecting unit 136.

It is determined whether the cable-cutting detecting circuit shown in FIG. 5 fails to detect the electric wave within the time set to the timer (Steps S606, S607). If YES in Step S606, it is determined that a trouble has developed in the high-frequency cable 12. In this case, a display unit 24 or the buzzer 138 operates, visually or aurally informing the operator of the trouble in the high-frequency cable 12 (Step S610). Further, the data representing this trouble is sent to the application provided in the host computer 2. In the host computer 2, the data is displayed on a display or the like. Thus, the high-frequency cable 12 is repaired or replaced by a new one (Step S611).

If the electric wave detecting unit 136 detects the electric wave, it is determined that the high-frequency cable 12 is working well. In this case, the display unit 24 or the buzzer 138 operates, visually or aurally informing the operator that the cable 12 is working well (Step S608). Then, the data representing this fact is sent to the application provided in the host computer 2. The host computer 2 displays this fact, informing the operator that there is no trouble (Step S609).

The LED indicator 113 emits light, giving information items such as the transmission state of the response requesting electric wave, the ON/OFF state of the main power supply of the wireless tag reader/writer main unit 13, the readiness of reading tag data at the host computer 2, the completion of tag-data reading at the host computer 2 and the reading error.

The host computer 2 comprises a control unit 21, a communications unit 22, an input unit 23, a display unit 24, and a storage unit 25. The control unit 21 is a central processing unit. The communications unit 22 can perform communication with the external communications unit 133 of the wireless tag reader/writer 1. The input unit 23 is, for example, a keyboard. The display unit 24 is, for example, a monitor. The storage unit 25 stores and manages various applications, software such as the drivers for hardware devices, and the tag date read from the wireless tag 3.

Two types of wireless tags are available at present. One is the active type that incorporates a power supply. The other is the passive type that transmits electric waves from the wireless tag reader/writer 1 and uses the electric waves as drive power. The wireless tag 3 used in the present embodiment may be either type.

As described above, the operator can operate the switch 112 to transmit a response requesting electric wave or stop transmitting the response requesting electric wave so that the antenna 111 of the hand-held antenna unit 11 may read the tag data from the wireless tag 3. In other words, the operator can control the timing of transmitting the electric wave and the timing of stop the transmission thereof, without operating the input unit 23 of the host computer 2.

Moreover, the LED indicator 113 enables the operator to conform the operating state of the wireless tag reader/writer main unit 13 and the tag data read from the wireless tag 3. Thus, the operator need not keep watching the display unit 24 of the host computer 2, while handling the hand-held antenna unit 11.

Furthermore, the wireless tag reader/writer 1 has high operability, being easy to operate to read tag data from the wireless tag 3, no matter whether the article having the tag 3 is placed on a high shelf or a low shelf. In addition, the wireless tag reader/writer 1 is simple in configuration and can yet reliably determine whether a trouble has developed in the high-frequency cable 12 or not.

### Second Embodiment

In the embodiment described above, the hand-held antenna unit 11 incorporates no power supply units and receives power from outside. The present invention is not limited to this configuration. A power supply may be provided in the hand-held antenna unit 11.

While holding the hand-held antenna unit 11 with hand, the operator may stop reading tag data from the wireless tag 3 attached to an article put on a shelf or the like.

While the tag-data reading is suspended, the hand-held antenna unit 11 is usually put on the holding base 13a that serves as cover of the wireless tag reader/writer main unit 13, as well. If the antenna unit 11 is placed on the holding base 13a, with the switch 112 turned off, no problems will arise at all because the antenna unit 11 radiates no electric waves. If the antenna unit 11 is placed on the holding base 13a, with the switch 112 turned on, however, the electric waves being radiated from the antenna unit 11 will be totally reflected by the base 13a if the holding base 13a is made of metal. Consequently, a large load will be exerted on the wireless tag reader/writer 1. In the worst case, the wireless tag reader/writer 1 may be damaged.

Assume that the wireless tag reader/writer main unit 13 is transported on a cart or the like, the hand-held antenna unit 11 may falls from the holding base 13a unless the hand-held antenna unit 11 is appropriately positioned on the holding base 13a.

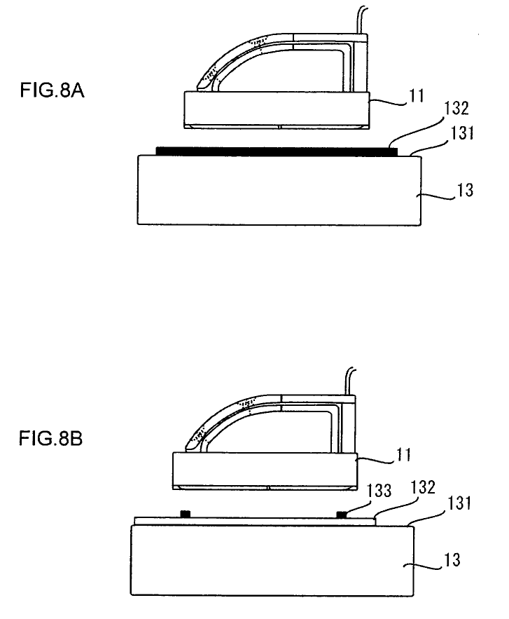

In view of this, an electric wave reflection suppressing member 13b is formed on the upper surface of the holding base 13a in the second embodiment. The member 13b is made of rubber and serves as cover of the wireless tag reader/writer main unit 13. The member 13b can suppress the total reflection of electric waves and can prevent the hand-held antenna unit 11 from slipping off the holding base 13a. FIGS. 8A and 8B are diagrams explaining the holding base 13a that serves as cover of the wireless tag reader/writer main unit 13. (refer to FIG. 8A).

An electric wave absorbing sheet made of ferrite or carbon may of course be formed on the upper surface of the holding base 13a, in place of the electric wave reflection suppressing member 13b. If this is the case, the adverse side of the electric wave absorbing member 13b, which may contact the hand-held antenna unit 11, should preferably have depressions and projections 13c and thus acquire a large coefficient of friction.

Assume that the hand-held antenna unit 11 incorporates a power supply. Then, even if the power supply is small and lightweight body the operator will be much tired, as he or she keeps holding the unit 11 and the tag data is being read from the wireless tags attached to articles placed on shelves. To reduce the fatigue, the operator may slide the hand-held antenna unit 11 in the scanning direction, while holding the lower surface of the antenna unit 11 in contact with the shelf.

If the friction between the shelf and the lower surface of the antenna unit 11 is large, it will be difficult for the operator to slide the hand-held antenna unit 11 on the shelf.

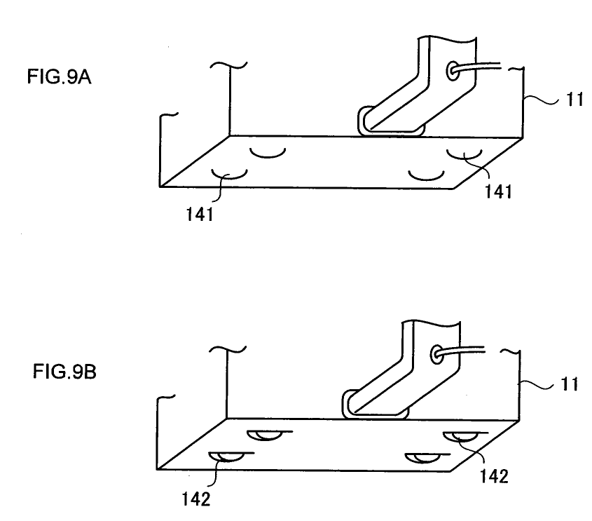

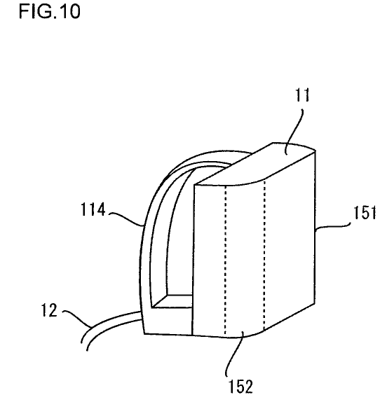

In order to reduce the friction, projections 141 are formed on the lower surface of the hand-held antenna unit 11 as shown in FIG. 9A. In order to reduce the friction, the projections 141 should better be hemispherical as illustrated in FIG. 9A, and each may be exposed to the shelf.

As shown in FIG. 9B, rollers 142 may be provided, in place of the hemispherical projections 141, on the lower surface of the hand-held antenna unit 11. Alternatively, balls (not shown) resembling the balls used in mouse (i.e., input devices for use with personal computers) may be provided on the lower surface of the hand-held antenna unit 11.

Owning to such measures taken, thus reducing the friction, the hand-held antenna unit 11 can be smoothly slid sideways. In particular, balls, if used, will enable the operator to move the antenna unit 11 smoothly, not only sideways but also back and forth.

The operator may push the antenna unit 11 onto an article placed on a shelf or the back of an article placed on a shelf, in order to read tag data. In this case, the antenna unit 11 contacts in frictional contact with the article. This lowers the operability of the hand-held antenna unit 11.

Not to lower the operability of the antenna unit 11, its antenna cover 151 may be chamfered at the edges 152 that extend in the lengthwise direction as is illustrated in FIG. 10. Of course, the edges 152 maybe rounded, instead of being chamfered. If configured in either way, the edges 152 do not contact the article as the hand-held antenna unit 11 is slid on the article. This ensures smooth sliding of the antenna unit 11.

In the present embodiment, the total reflection of electric waves can be prevented even if the hand-held antenna unit 11 radiating electric waves remains mounted on the wireless tag reader/writer main unit 13 while the tag data is being read from the wireless tag 3. Hence, the wireless tag reader/writer 1 can be free of damages or malfunctioning.

Since the hand-held antenna unit 11 can be smoothly slid, the operator can easily read tag data.

### Third Embodiment

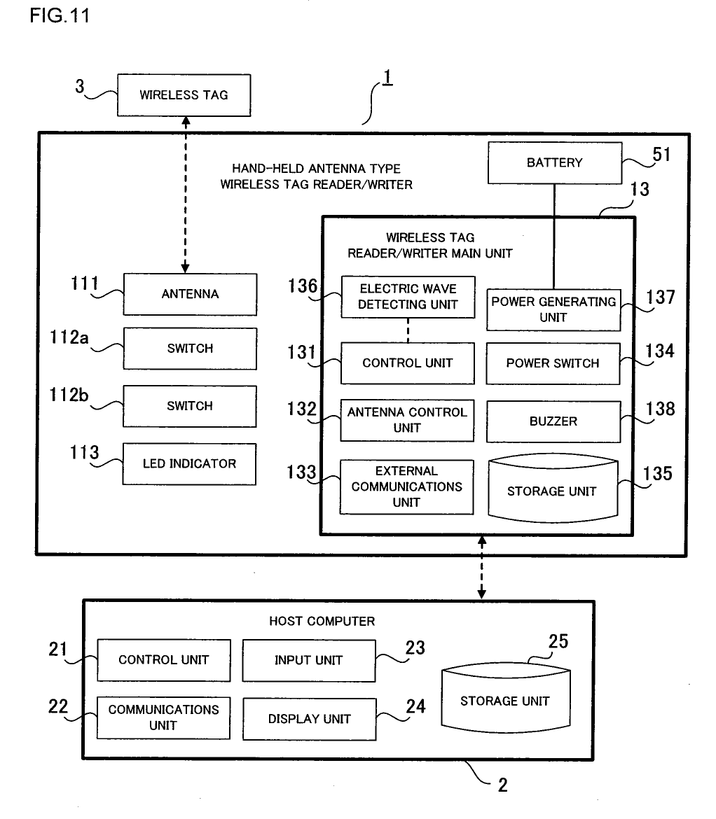

FIG. 11 is a block diagram showing the overall configuration of a wireless tag data management system according to a third embodiment of the present invention. As FIG. 11 shows, a hand-held antenna unit 11 is integrated with a wireless tag reader/writer unit 1. Further, wireless tag reader/writer unit 1 incorporates a power supply. The wireless tag reader/writer 1, which comprises the hand-held antenna unit 11 and the wireless tag reader/writer unit 1, can transmit and receive data to and from a host computer 2, using a wireless LAN, infrared communication such as infrared data association (IrDA), or wired communication.

So configured, the wireless tag data management system has a self-diagnosis function of determining whether the hand-held antenna type wireless tag reader/writer 1 is radiating electric waves in a normal manner.

Further, the hand-held antenna unit 11 may be configured as shown in FIG. 9A or FIG. 9B. In this case, the unit 11 can acquire high operability, though the hand-held antenna type wireless tag reader/writer 1 incorporates a power supply.

It should be noted that the present invention is not limited to the embodiments described above. The components of any embodiment can be modified in various manners in reducing the invention to practice, without departing from the sprit or scope of the invention. Further, the components of the embodiments described above may be combined, if necessary, in appropriate ways, thereby to make different inventions. Still further, some of the component of any embodiment may not be used.

What is claimed is:

1. A handy-type wireless tag reader/writer having a wireless tag reader/writer unit configured to control communication with a wireless tag, and a hand-held antenna unit connected to the wireless tag reader/writer unit by a cable,
wherein the hand-held antenna unit comprises:
an antenna unit configured to transmit a response requesting electric wave to the wireless tag under the control of the wireless tag reader/writer unit, and to receive a response electric wave that the wireless tag reader/writer unit transmits in response to the response requesting electric wave;
a grip part attached to the antenna unit; and
at least two switches provided on the grip part and configured to cause the antenna unit to start transmitting the response requesting electric wave when the wireless tag reader/writer unit is prepared to transmit the response requesting electric wave and to stop transmitting the response requesting electric wave while the response requesting electric wave is being transmitted.

2. The handy-type wireless tag reader/writer according to claim 1, wherein one of the switches is arranged at an almost middle part of the grip part, and another of the switches is arranged at one end of the grip part and located remote from the cable.

3. The handy-type wireless tag reader/writer according to claim 2, wherein the switch arranged at an almost middle part of the grip part is used to read tag data from an article placed at a high position such as a high shelf, and the switch arranged at one end of the grip part is used to read tag data from an article placed at a low position such as a low shelf.

4. The handy-type wireless tag reader/writer according to claim 1, wherein the cable is a high-frequency cable or a RF cable, and the wireless tag reader/writer unit has an electric wave detecting unit which has a second antenna unit configured to receive power transmitted from the antenna unit.

5. The handy-type wireless tag reader/writer according to claim 4, wherein the electric wave detecting unit comprises the second antenna unit having a length of λ/2, where λ is the oscillation frequency of the wireless tag, a rectifying diode arranged between the first and second antenna units, and a light-emitting diode (LED) connected between the rectifying diode and the second antenna unit.

6. The handy-type wireless tag reader/writer according to claim 5, wherein the electric wave detecting unit undergoes resonance and the LED is thereby turned on, when the second antenna unit receives a electric wave from the first antenna unit.

7. The handy-type wireless tag reader/writer according to claim 4, wherein the electric wave detecting unit comprises the second antenna unit having a length of λ/2, where λ is the oscillation frequency of the wireless tag, a rectifying diode arranged between the first and second antenna units, and a photocoupler connected between the rectifying diode and the second antenna unit.

8. The handy-type wireless tag reader/writer according to claim 7, wherein when the second antenna unit receives a electric wave from the first antenna unit, the electric wave detecting unit undergoes resonance, generating a current, the current is converted to a digital signal via the photocoupler, and the electric wave detecting unit determines whether the RF cable is cut.

9. The handy-type wireless tag reader/writer according to claim 4, further comprising a display unit or an alarm unit, which is configured to display the detected result or alarm a detected trouble be a signal sound when the electric wave detecting unit detects that the high-frequency cable or the RF cable has been cut.

10. A handy-type wireless tag reader/writer comprising:
a wireless tag reader/writer unit having a grip part and configured to control communication with a wireless tag;
an antenna unit configured to transmit a response requesting electric wave to the wireless tag under the control of the wireless tag reader/writer unit, and to receive a response electric wave that the wireless tag reader/writer unit transmits in response to the response requesting electric wave;
a battery; and
a communications unit configured to transmit and receive data to and from an external host computer,
wherein at least two switches are provided on the grip part and configured to cause the antenna unit to start transmitting the response requesting electric wave when the wireless tag reader/writer unit is prepared to transmit the response requesting electric wave and to stop transmitting the response requesting electric wave while the response requesting electric wave is being transmitted.

11. The handy-type wireless tag reader/writer according to claim 10, wherein the antenna unit is connected to the wireless tag reader/writer unit by a cable, and one of the switches is arranged at an almost middle part of the grip part, and another of the switches is arranged at one end of the grip part and located remote from the cable.

12. The handy-type wireless tag reader/writer according to claim 10, wherein the switch arranged at an almost middle part of the grip part is used to read tag data from an article placed at a high position such as a high shelf, and the switch arranged at one end of the grip part is used to read tag data from an article placed at a low position such as a low shelf.

13. The handy-type wireless tag reader/writer according to claim 10, wherein the cable is a high-frequency cable or a RF cable, and the wireless tag reader/writer unit has a electric wave detecting unit which has a second antenna unit configured to receive power transmitted from the first antenna unit.

14. The handy-type wireless tag reader/writer according to claim 13, wherein the electric wave detecting unit comprises the second antenna unit having a length of λ/2, where λ is the oscillation frequency of the wireless tag, a rectifying diode arranged between the first and second antenna units, and a light-emitting diode (LED) connected between the rectifying diode and the second antenna unit.

15. The handy-type wireless tag reader/writer according to claim 14, wherein the electric wave detecting unit undergoes resonance, generating a current and the LED is thereby turned on, when the second antenna unit receives a electric wave from the first antenna unit.

16. The handy-type wireless tag reader/writer according to claim 13, wherein the electric wave detecting unit comprises the second antenna unit having a length of λ/2, where λ is the oscillation frequency of the wireless tag, a rectifying diode arranged between the first and second antenna units, and a photocoupler connected between the rectifying diode and the second antenna unit.

17. The handy-type wireless tag reader/writer according to claim 16, wherein when the second antenna unit receives a electric wave from the first antenna unit, the electric wave detecting unit undergoes resonance, generating a current, the current is converted to a digital signal via the photocoupler, and the electric wave detecting unit determines whether the RF cable is cut.

18. The handy-type wireless tag reader/writer according to claim 13, further comprising a display unit or an alarm unit, which is configured to display the detected result or alarm a detected by a signal sound when the electric wave detecting unit detects that the high-frequency cable or the RF cable has been cut.

19. A handy-type wireless tag reader/writer having a wireless tag reader/writer unit configured to control communication with a wireless tag, and a hand-held antenna unit connected to the wireless tag reader/writer unit by a cable,
wherein the hand-held antenna unit comprises:
a power-supply unit;
an antenna unit configured to transmit a response requesting electric wave to the wireless tag under the control of the wireless tag reader/writer unit, and to receive a response electric wave that the wireless tag reader/writer unit transmits in response to the response requesting electric wave;
a grip part attached to the antenna unit; and
at least two switches provided on the grip part and configured to cause the antenna unit to start transmitting the response requesting electric wave when the wireless tag reader/writer unit is prepared to transmit the response requesting electric wave and to stop transmitting the response requesting electric wave while the response requesting electric wave is being transmitted,
wherein a electric wave reflection suppressing member is formed on an upper surface of the wireless tag reader/writer unit.

20. The handy-type wireless tag reader/writer according to claim 19, wherein the electric wave reflection suppressing member is made of rubber.

21. The handy-type wireless tag reader/writer according to claim 19, wherein a wave-absorbing sheet is formed on the upper surface of the wireless tag reader/writer unit.

22. The handy-type wireless tag reader/writer according to claim 21, wherein the wave-absorbing sheet contains ferrite and carbon mixed together.

23. The handy-type wireless tag reader/writer according to claim 22, wherein depressions and projections are provided at a surface of the electric wave absorbing sheet.

24. The handy-type wireless tag reader/writer according to claim 19, wherein the hand-held antenna unit has projections on a lower side that is to contact a shelf on which an article having the wireless tag is placed.

25. The handy-type wireless tag reader/writer according to claim 24, wherein the projections are hemispherical.

26. The handy-type wireless tag reader/writer according to claim 19, wherein the hand-held antenna unit has rollers on a lower side that is to contact a shelf on which an article having the wireless tag is placed.

27. The handy-type wireless tag reader/writer according to claim 19, wherein the hand-held antenna unit has balls on a lower side that is to contact a shelf on which an article having the wireless tag is placed.

28. The handy-type wireless tag reader/writer according to claim 19, wherein the hand-held antenna unit has a cover having edges that face an article, extend in a lengthwise direction of the grip part and are chamfered.

29. A handy-type wireless tag reader/writer comprising:
a wireless tag reader/writer unit having a grip part and configured to control communication with a wireless tag;
an antenna unit configured to transmit a response requesting electric wave to the wireless tag under the control of the wireless tag reader/writer unit, and to receive a response electric wave that the wireless tag reader/writer unit transmits in response to the response requesting electric wave;
a battery; and
a communications unit configured to transmit and receive data to and from an external host computer,
wherein at least two switches are provided on the grip part and configured to cause the antenna unit to start transmitting the response requesting electric wave when the wireless tag reader/writer unit is prepared to transmit the response requesting electric wave and to stop transmitting the response requesting electric wave while the response requesting electric wave is being transmitted; and
a electric wave reflection suppressing member is formed on an upper surface of the wireless tag reader/writer unit.

30. The handy-type wireless tag reader/writer according to claim 29, wherein a electric wave reflection suppressing member is formed on an upper surface of the wireless tag reader/writer unit.

31. The handy-type wireless tag reader/writer according to claim 29, wherein a wave-absorbing sheet is formed on the upper surface of the wireless tag reader/writer unit.

32. The handy-type wireless tag reader/writer according to claim 31, wherein the wave-absorbing sheet contains ferrite and carbon mixed together.

33. The handy-type wireless tag reader/writer according to claim 32, wherein depressions and projections are provided at a surface of the wave-absorbing sheet.

34. The handy-type wireless tag reader/writer according to claim 29, wherein the hand-held antenna unit has projections on a lower side that is to contact a shelf on which an article having the wireless tag is placed.

35. The handy-type wireless tag reader/writer according to claim 34, wherein the projections are hemispherical.

36. The handy-type wireless tag reader/writer according to claim 29, wherein the hand-held antenna unit has rollers on a lower side that is to contact a shelf on which an article having the wireless tag is placed.

37. The handy-type wireless tag reader/writer according to claim 29, wherein the hand-held antenna unit has balls on a lower side that is to contact a shelf on which an article having the wireless tag is placed.

38. The handy-type wireless tag reader/writer according to claim 29, wherein the hand-held antenna unit has a cover having edges that face an article, extend in a lengthwise direction of the grip part and are chamfered.
